(19) United States
(12) Patent Application Publication
(10) Pub. No.: US 2022/0022482 A1
(43) Pub. Date: Jan. 27, 2022

(54) CUP FOR A DEVICE FOR PREPARING A FROZEN FOOD PRODUCT FROM A LIQUID MIXTURE AND THE DEVICE

(71) Applicant: Frederik Van Isacker, Zaventem (BE)

(72) Inventor: Frederik Van Isacker, Zaventem (BE)

(73) Assignee: KEMPISCHE BRIK CENTRALE, Zaventem (BE)

(21) Appl. No.: 17/021,707

(22) Filed: Sep. 15, 2020

Related U.S. Application Data
(63) Continuation of application No. PCT/EP2020/070860, filed on Jul. 23, 2020.

(51) Int. Cl. A23G 9/12; A23G 9/22; B01F 7/16; B01F 7/30; B01F 7/18

(52) U.S. Cl. CPC A23G 9/12; A23G 9/22; B01F 2215/0021; B01F 7/30; B01F 7/18; B01F 7/161

(57) ABSTRACT

A cup is provided for a device for preparing a frozen food product from a liquid mixture with a stirring element of the device stirring the liquid mixture in the cup while the cup is being cooled by a cooling unit of the device. The device includes a cup holder with a cavity for receiving the cup. The cup holder includes a first upper surface surrounding an entrance opening of the cavity, and is provided on the first upper surface with at least one upwards first protrusion. The cup has a predetermined height such that the cup extends a predetermined distance above the first upper surface. The cup includes at its top a circumferential flange provided with at least one first extension, which is arranged such that it contacts the at least one first protrusion for preventing rotation of the cup in the cavity.

### TECHNICAL FIELD

The present disclosure relates to a cup for a device for preparing a frozen food product, such as for example ice cream or sorbet, from a liquid mixture, preferably in individual portions. The present disclosure also relates to a device for preparing a frozen food product from a liquid mixture.

### BACKGROUND

US 2017/0225879 A1 and WO 2015/006802 A1 both show a device for preparing a frozen food product from a liquid mixture, and a removable cup or container for the device in which the frozen food product is to be prepared from the liquid mixture. Said devices comprise a cup holder with a cavity for receiving the cup. The cavity has an entrance opening which is surround by an upper surface of the cup holder. Said devices also comprise a cooling unit configured for cooling the cavity of the cup holder, and a stirring unit configured for stirring the liquid mixture in the cup by a stirring element for preparing the frozen food product. The stirring unit comprises a drive system for driving the stirring motion of the stirring element in the cup.

The cup of US 2017/0225879 A1 is used for preparing individual portions of the frozen food product. The cup comprises at its top a circumferential flange, wherein the circumferential flange is provided with two extensions, i.e. locking elements. When the cup is received in the cavity of the cup holder, these extensions engage with a complementary fixed feature integrated in or extending from the upper surface of the cup holder. This prevents the cup from rotating in the cup holder when the frozen food product is being prepared in the cup by stirring the liquid mixture in the cup by a stirring element of the device. This cup has however the disadvantage that the circumferential flange of the cup is supported directly on the upper surface of the cup holder when the cup is received in the cavity of the cup holder. This makes it difficult to grab onto the cup to take it out of the cup holder when the frozen food product has been prepared.

The cup of WO 2015/006802 A1 is used for preparing larger portions of the frozen food product, thus not individual portions. The cup is provided at the upper extent with a pair of opposing protrusion on the outer side of the cup wall. When the cup is received in the cavity of the cup holder, these protrusions engage with opposing recesses in the inner wall of the cavity. This prevents the cup from rotating in the cup holder when the frozen food product is being prepared in the cup by stirring the liquid mixture in the cup by a stirring element of the device. This cup has however the disadvantage that the cup is completely received in the cavity of the cup holder, which makes it difficult to take the cup out of the cup holder when the frozen food product has been prepared. For this purpose, the cup is however provided with a pivoting wire handle, which has the disadvantage that the cup becomes more complex and expensive to produce.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

It is an aim of the present disclosure to provide a simple and convenient cup for a device for preparing a frozen food product from a liquid mixture and said device, wherein the cup is easy to take out of the cup holder of the device, and wherein the cup is prevented from rotating within the cup holder of the device when the frozen food product is being prepared in the cup by stirring the liquid mixture in the cup by a stirring element of the device.

The aim of the present disclosure, or others, is achieved with a cup showing the technical characteristics of the first independent claim, and with a device showing the technical characteristics of the second independent claim.

Therefore, the present disclosure provides a cup or container for a device for preparing a frozen food product, such as for example ice cream or sorbet, from a liquid mixture. In some embodiments, the device is the device according to the present disclosure as described below. In some embodiments, the cup is arranged for preparing the frozen food product therein from the liquid mixture by a stirring element of the device stirring the liquid mixture in the cup while the cup is being cooled by a cooling unit of the device. In some embodiments, the cup comprises a cup wall enclosing a holding volume for the liquid mixture and the frozen food product. In some embodiments, the cup comprises a top opening to the holding volume. The device comprises a cup holder. The cup holder comprises a cavity arranged for receiving the cup. In some embodiments, the cavity is arranged for fittingly receiving the cup. In some embodiments, the cup wall has at the outside of the cup a shape complementary to the shape of an inner wall of the cavity. The cup holder comprises a first upper surface surrounding an entrance opening of the cavity. The cup holder is provided on the first upper surface with at least one first protrusion extending upwards from the first upper surface. The cup has a predetermined height such that the cup extends a predetermined distance above the first upper surface of the cup holder, when the cup is received in the cavity of the cup holder of the device. The cup comprises at its top a circumferential flange. In some embodiments, the circumferential flange extends outwards and sideways from the cup. In some embodiments, the circumferential flange extends completely around the cup or the top opening of the cup, but may also extends partially around the cup or the top opening of the cup. The circumferential flange is provided with at least one first extension. The at least one first extension is arranged such that the at least one first extension contacts the at least one first protrusion for preventing rotation of the cup in the cavity, when the cup is received in the cavity of the cup holder of the device. In some embodiments, the at least one first extension contacts at least one side of the at least one first protrusion. In some embodiments, said at least one side of the at least one first protrusion is located along a rotation direction.

The cup according to the present disclosure offers the advantage that the cup, when received in the cavity of the cup holder of the device, and specifically the circumferential flange at the top of the cup, extends a predetermined distance above the first upper surface of the cup holder, such that the circumferential flange can be easily grabbed from the sides for taking the cup out of the cup holder when the frozen food product has been prepared.

The cup according to the present disclosure also offers the advantage that, when the cup is received in the cavity of the cup holder of the device, the least one first extension of the circumferential flange contacting the at least one first protrusion on the first upper surface of the cup holder provides a simple means for preventing the rotation of the cup inside the cavity. Even in case the cup would be received in such a way in the cavity that the at least one first extension is not contacting the at least one first protrusion, then a rotation of the cup in the cavity would inevitably lead to the at least one first extension contacting the at least one first protrusion, thereby preventing further rotation of the cup in the cavity.

In an embodiment of the cup according to the present disclosure the predetermined distance is at least 2 mm, more preferably at least 3 mm, even more preferably at least 4 mm, and yet even more preferably at least 5 mm. In an embodiment of the cup according to the present disclosure the predetermined distance is at most 15 mm, more preferably at most 13 mm, even more preferably at most 11 mm, and yet even more preferably at most 10 mm.

In an embodiment of the cup according to the present disclosure the at least one first extension extends sideways from the circumferential flange for contacting the at least one first protrusion, when the cup is received in the cavity of the cup holder of the device. This embodiment of the cup is intended for use with a device wherein the at least one first protrusion extends upwards from the first upper surface up to at least the predetermined distance above the first upper surface.

In an embodiment of the cup according to the present disclosure at least a part of the at least one first extension extends downwards with respect to the circumferential flange for contacting the at least one first protrusion, when the cup is received in the cavity of the cup holder of the device.

This embodiment of the cup can be used with a device wherein the at least one first protrusion extends upwards from the first upper surface up to at most the predetermined distance above the first upper surface, whereby the at least one first extension is still able to contact the at least one first protrusion by extending downwards to the at least one first protrusion. This embodiment can however also be used with a device wherein the at least one first protrusion extends upwards from the first upper surface up to at least the predetermined distance above the first upper surface.

In an embodiment of the cup according to the present disclosure the circumferential flange is provided at least along a part of its circumference with a second extension which extends downwards from the circumferential flange.

This embodiment offers the advantage that the second extension extending downwards from the circumferential flange offers a larger surface to grab onto for taking the cup out of the cup holder when the frozen food product has been prepared. Hence, this embodiment makes it easier to take the cup out of the cup holder.

In an embodiment of the cup according to the present disclosure the second extension extends downwards from the circumferential flange up to the first upper surface, when the cup is received in the cavity of the cup holder of the device.

This embodiment offers the advantage that the surface to grab onto for taking the cup out of the cup holder is maximised, such that it is even more easy to take the cup out of the cup holder.

In an embodiment of the cup according to the present disclosure the at least one first extension is arranged for contacting the at least one first protrusion on opposing sides of the at least one first protrusion, when the cup is received in the cavity of the cup holder of the device. In some embodiments, said opposing sides of the at least one first protrusion are located along a rotation direction.

This embodiment offers the advantage that, when the cup is received in the cavity of the cup holder of the device, the least one first extension contacting the at least one first protrusion on opposing sides prevents the rotation of the cup inside the cavity in opposite senses along a rotation direction.

In an embodiment of the cup according to the present disclosure the circumferential flange is provided with a plurality of the first extensions which are arranged rotationally symmetric on the circumferential flange. In an embodiment of the cup according to the present disclosure the circumferential flange is provided with a plurality of the first extensions which are arranged equidistantly on the circumferential flange.

This embodiment offers the advantage that the cup can be received in the cavity of the cup holder in the plurality of positions, where in each position at least one of the first extensions is contacting a first protrusion on the first upper surface of the cup holder. This makes it easier to quickly position the cup in the correct position in the cavity for preventing rotation of the cup in the cavity.

With this embodiment, the first upper surface of the cup holder may be provided with the same number of first protrusions as the number of the first extensions of the circumferential flange. These first protrusions then have to be arranged rotationally symmetric or equidistantly around the entrance opening of the cavity in a corresponding manner as the first extensions are arranged on the circumferential flange. The number of first protrusions may also be lower than the number of the first extensions of the circumferential flange, as long as the first protrusions are arranged around the entrance opening of the cavity at the same angles or multiples thereof from each other as the angles between the first extensions on the circumferential flange. It is also possible to make use of a single first protrusion.

In an embodiment of the cup according to the present disclosure the cup contains the liquid mixture for preparing the frozen food product.

In an embodiment of the cup according to the present disclosure the cup is provided with a sealing element for containing the liquid mixture in the cup. The sealing element is removable. In some embodiments, the sealing element is provided for sealing of the top opening of the cup.

In an embodiment of the cup according to the present disclosure the cup is reusable.

The present disclosure further provides a device for preparing a frozen food product, such as for example ice cream or sorbet, from a liquid mixture. The device comprises a cup or container in which the frozen food product is to be prepared from the liquid mixture. In some embodiments, the cup comprises a cup wall enclosing a holding volume for the liquid mixture and the frozen food product. In some embodiments, the cup comprises a top opening to the holding volume. In some embodiments, the cup is the cup according to the present disclosure. The device comprises a cup holder. The cup holder comprises a cavity receiving the cup. In some embodiments, the cavity is fittingly receiving the cup. In some embodiments, the cup wall has at the outside of the cup a shape complementary to the shape of an inner wall of the cavity. In some embodiments, the cup is removable from the cavity. The cup holder comprises a first upper surface surrounding an entrance opening of the cavity. The device comprises a cooling unit configured for cooling the cavity of the cup holder. The device comprises a stirring unit configured for stirring the liquid mixture in the cup by a stirring element for preparing the frozen food product. In some embodiments, the stirring element is configured for scraping frozen liquid mixture from the cup wall at the inside of the cup when stirring the liquid mixture in the cup. The stirring unit comprises a drive system for driving the stirring motion of the stirring element in the cup. In some embodiments, the stirring unit is arranged above the cup holder. In some embodiments, the stirring element is removably connected to the stirring unit. The cup extends a predetermined distance above the first upper surface of the cup holder. In some embodiments, the cup has a predetermined height such that the cup extends the predetermined distance above the first upper surface of the cup holder. The cup comprises at its top a circumferential flange. In some embodiments, the circumferential flange extends outwards and sideways from the cup. In some embodiments, the circumferential flange extends completely around the cup or the top opening of the cup, but may also extends partially around the cup or the top opening of the cup. The circumferential flange is provided with at least one first extension. The cup holder is provided on the first upper surface with at least one first protrusion extending upwards from the first upper surface. The at least one first extension and the at least one first protrusion are arranged such that the at least one first extension contacts the at least one first protrusion for preventing rotation of the cup in the cavity. In some embodiments, the at least one first extension contacts at least one side of the at least one first protrusion. In some embodiments, said at least one side of the at least one first protrusion is located along a rotation direction.

The device according to the present disclosure offers the advantage that the cup, and specifically the circumferential flange at the top of the cup, extends a predetermined distance above the first upper surface of the cup holder, such that the circumferential flange can be easily grabbed from the sides for taking the cup out of the cup holder when the frozen food product has been prepared.

The device according to the present disclosure also offers the advantage that the least one first extension of the circumferential flange contacting the at least one first protrusion on the first upper surface of the cup holder provides a simple means for preventing the rotation of the cup inside the cavity. Even in case the cup would be received in such a way in the cavity that the at least one first extension is not contacting the at least one first protrusion, then a rotation of the cup in the cavity would inevitably lead to the at least one first extension contacting the at least one first protrusion, thereby preventing further rotation of the cup in the cavity.

In an embodiment of the device according to the present disclosure the predetermined distance is at least 2 mm, more preferably at least 3 mm, even more preferably at least 4 mm, and yet even more preferably at least 5 mm. In an embodiment of the cup according to the present disclosure the predetermined distance is at most 15 mm, more preferably at most 13 mm, even more preferably at most 11 mm, and yet even more preferably at most 10 mm.

In an embodiment of the device according to the present disclosure the at least one first protrusion extends upwards from the first upper surface up to at least the predetermined distance above the first upper surface. The at least one first extension extends sideways from the circumferential flange for contacting the at least one first protrusion.

In an embodiment of the device according to the present disclosure at least a part of the at least one first extension extends downwards with respect to the circumferential flange for contacting the at least one first protrusion. Optionally, the at least one first protrusion extends upwards from the first upper surface up to at most the predetermined distance above the first upper surface.

In an embodiment of the device according to the present disclosure the circumferential flange is provided at least along a part of its circumference with a second extension which extends downwards from the circumferential flange.

This embodiment offers the advantage that the second extension extending downwards from the circumferential flange offers a larger surface to grab onto for taking the cup out of the cup holder when the frozen food product has been prepared. Hence, this embodiment makes it easier to take the cup out of the cup holder.

In an embodiment of the device according to the present disclosure the second extension extends downwards from the circumferential flange up to the first upper surface.

This embodiment offers the advantage that the surface to grab onto for taking the cup out of the cup holder is maximised, such that it is even more easy to take the cup out of the cup holder.

In an embodiment of the device according to the present disclosure the cup holder is provided on the first upper surface at the circumference of the cavity with a second protrusion which extends upwards from the first upper surface and which surrounds the entrance opening of the cavity.

This embodiment offers the advantage that the part of the cup extending above the first upper surface of the cup holder extending above the first upper surface is supported by the second protrusion. When used in combination with a cup having a second extension extending downwards from the circumferential flange, the second protrusion can also be used beneficially for supporting the second extension, for example when the second extension is grabbed onto for taking the cup out of the cavity of the cup holder.

In an embodiment of the device according to the present disclosure the second protrusion extends upwards from the first upper surface up to the predetermined distance above the first upper surface.

This embodiment offers the advantage that the part of the cup extending above the first upper surface of the cup holder extending above the first upper surface is fully supported by the second protrusion. This embodiment also offers the advantage that the circumferential flange of the cup is supported, and fully supported if the second protrusion has substantially the same width as the circumferential flange. When used in combination with a cup having a second extension extending downwards from the circumferential flange, the second protrusion of this embodiment can also be used beneficially for fully supporting the second extension.

In an embodiment of the device according to the present disclosure the at least one first protrusion extends sideways from the second protrusion.

This embodiment offers the advantage that the at least one first protrusion is connected to the second protrusion, such that there are no spaces between the at least one first protrusion and the second protrusion in which liquid mixture or frozen food product spilling out of the cup while preparing the frozen food product may get stuck. This makes it easier to clean the device, and is also beneficial for the hygienic usage of the device.

In an embodiment of the device according to the present disclosure the at least one first extension is arranged for contacting the at least one first protrusion on opposing sides of the at least one first protrusion. In some embodiments, said opposing sides of the at least one first protrusion are located along a rotation direction.

This embodiment offers the advantage that the least one first extension contacting the at least one first protrusion on opposing sides prevents the rotation of the cup inside the cavity in opposing senses along a rotation direction.

In an embodiment of the device according to the present disclosure the circumferential flange is provided with a plurality of the first extensions which are arranged rotationally symmetric on the circumferential flange. In an embodiment of the device according to the present disclosure the circumferential flange is provided with a plurality of the first extensions which are arranged equidistantly on the circumferential flange.

This embodiment offers the advantage that the cup can be received in the cavity of the cup holder in the plurality of positions, where in each position at least one of the first extensions is contacting a first protrusion on the first upper surface of the cup holder. This makes it easier to quickly position the cup in the correct position in the cavity for preventing rotation of the cup in the cavity.

With this embodiment, the first upper surface of the cup holder may be provided with the same number of first protrusions as the number of the first extensions of the circumferential flange. These first protrusions then have to be arranged rotationally symmetric or equidistantly around the entrance opening of the cavity in a corresponding manner as the first extensions are arranged on the circumferential flange. The number of first protrusions may also be lower than the number of the first extensions of the circumferential flange, as long as the first protrusions are arranged around the entrance opening of the cavity at the same angles or multiples thereof from each other as the angles between the first extensions on the circumferential flange. It is also possible to make use of a single first protrusion.

In an embodiment of the device according to the present disclosure the cup holder is provided with a plurality of the first protrusions which are arranged rotationally symmetric around the entrance opening of the cavity. In an embodiment of the device according to the present disclosure the cup holder is provided with a plurality of the first protrusions which are arranged equidistantly around the entrance opening of the cavity.

This embodiment offers the advantage that the cup can be received in the cavity of the cup holder in the plurality of positions, where in each position a first extension of the circumferential flange is contacting at least one of the first protrusions. This makes it easier to quickly position the cup in the correct position in the cavity for preventing rotation of the cup in the cavity.

With this embodiment, the circumferential flange of the cup may be provided with the same number of first extensions as the number of the first protrusion on the first upper surface of the cup holder. These first extensions then have to be arranged rotationally symmetric or equidistantly on the circumferential flange in a corresponding manner as the first protrusions are arranged around the entrance opening of the cavity. The number of first extensions may also be lower than the number of the first protrusions on the first upper surface of the cup holder, as long as the first extensions are arranged on the circumferential flange at the same angles or multiples thereof from each other as the angles between the first protrusions around the entrance opening of the cavity. It is also possible to make use of a single first extension.

In an embodiment of the device according to the present disclosure the cup holder comprises in a second upper surface a recessed area surrounding the entrance opening of the cavity. A bottom surface of the recessed area forms the first upper surface of the cup holder.

This embodiment offers the advantage that liquid mixture or frozen food product accidentally spilling out of the cup while preparing the frozen food product is contained inside the recessed area, thereby preventing the spilled liquid mixture or frozen food product from further spreading over the device. This makes it easier to clean the device, and is beneficial for hygiene by preventing spilled liquid mixture or frozen food product from being left behind on difficult to clean places of the device.

In an embodiment of the device according to the present disclosure the stirring unit is arranged above the cup holder. The stirring unit comprises a moveable portion. The moveable portion is moveable along a height direction between a first position and a second position. In the first position the stirring element is arranged outside of the cup. In the second position the stirring element is arranged inside the cup for stirring the liquid mixture for preparing the frozen food product. The stirring unit is provided with a protection screen extending downwards from the moveable portion of the stirring unit. The protection screen is arranged such that a bottom edge of the protection screen supports on the first upper surface when the moveable portion of the stirring unit is in the second position. In some embodiments, the protection screen and the recessed area are arranged such that a bottom edge of the protection screen supports on the first upper surface near an edge of the recessed area when the moveable portion of the stirring unit is in the second position.

This embodiment is beneficial for the safety of the device by closing off the area above the cup between the cup holder and the moveable portion of the stirring unit, such that no access to the moving stirring element is possible when the frozen food product is being prepared from the liquid mixture by the stirring element stirring the liquid mixture in the cup while the cup is being cooled by the cooling unit.

In combination with the embodiment of the device having the recessed area in the second upper surface, this embodiment also offers the advantage that the bottom edge of the protection screen supporting on the first upper surface, i.e. the bottom surface of the recessed area, makes it more difficult to grab underneath the protection screen to lift it up and get access to the area above the cup between the cup holder and the moveable portion of the stirring unit while the frozen food product is being prepared. This is beneficial for the safety of the device.

This embodiment also offers the advantage that liquid mixture or frozen food product spilling out of the cup while preparing the frozen food product is contained on the first upper surface by the protection screen, thereby preventing the spilled liquid mixture or frozen food product from further spreading over the device. This makes it easier to clean the device, and is beneficial for hygiene by preventing spilled liquid mixture or frozen food product from being left behind on difficult to clean places of the device.

### DESCRIPTION OF THE DRAWINGS

The disclosed subject matter will be further elucidated by the following description and the appended figures.

FIG. 1A shows a device for preparing a frozen food product from a liquid mixture according to an embodiment of the present disclosure.

FIG. 1B shows the device of FIG. 1A where a protection screen is omitted for illustration purposes.

FIG. 2A shows a cross section through the cup holder of the device of FIG. 1A.

FIG. 2B shows a cross section through the cup holder of the device of FIG. 1A, wherein a cup is received in the cavity of the cup holder.

FIG. 3A shows the drive system of the device of FIG. 1A with a connected stirring element arranged in a cup.

FIG. 3B shows a cross section through the drive system as shown in FIG. 3A.

FIG. 4 shows a perspective view of the stirring element of the device of FIG. 1A.

FIG. 5A shows a perspective view of a cup according to an embodiment of the present disclosure.

FIG. 5B shows a top view of the cup of FIG. 5A.

FIG. 5C shows a side view of the cup of FIG. 5A.

FIG. 6A shows a perspective view of a cup according to another embodiment of the present disclosure.

FIG. 6B shows a perspective view of a cup holder according to another embodiment of the present disclosure for use with the cup of FIG. 6A.

FIG. 6C shows a top view of the cup of FIG. 6A received in the cavity of the cup holder of FIG. 6B.

FIG. 7A shows a perspective view of a cup according to another embodiment of the present disclosure.

FIG. 7B shows a perspective view of a cup holder according to another embodiment of the present disclosure for use with the cup of FIG. 7A.

FIG. 7C shows a top view of the cup of FIG. 7A received in the cavity of the cup holder of FIG. 7B.

FIG. 8A shows a perspective view of a cup according to another embodiment of the present disclosure.

FIG. 8B shows a perspective view of a cup holder according to another embodiment of the present disclosure for use with the cup of FIG. 8A.

FIG. 8C shows a top view of the cup of FIG. 8A received in the cavity of the cup holder of FIG. 8B.

### DETAILED DESCRIPTION

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

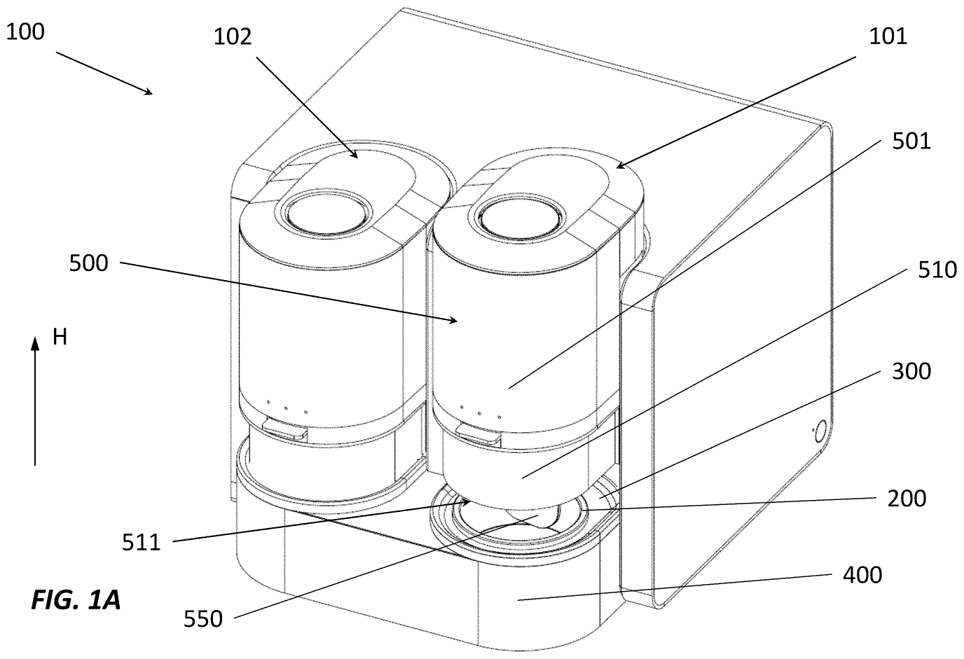

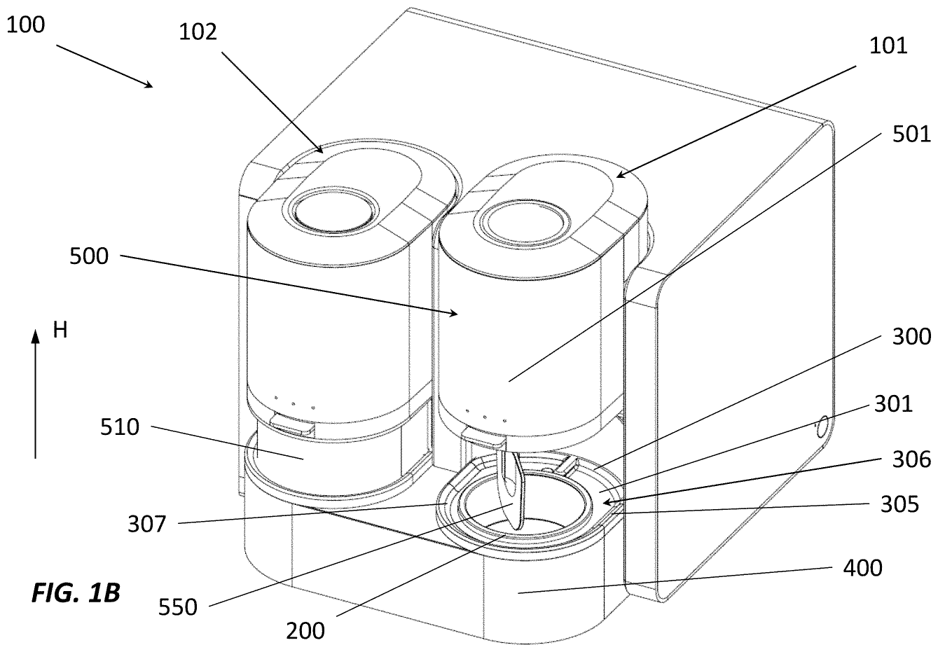

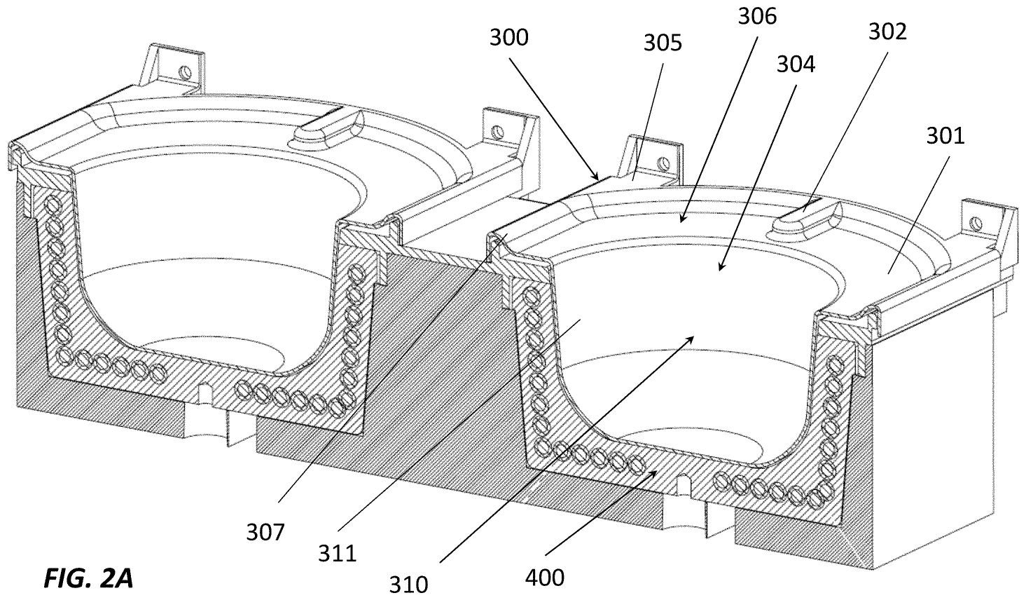

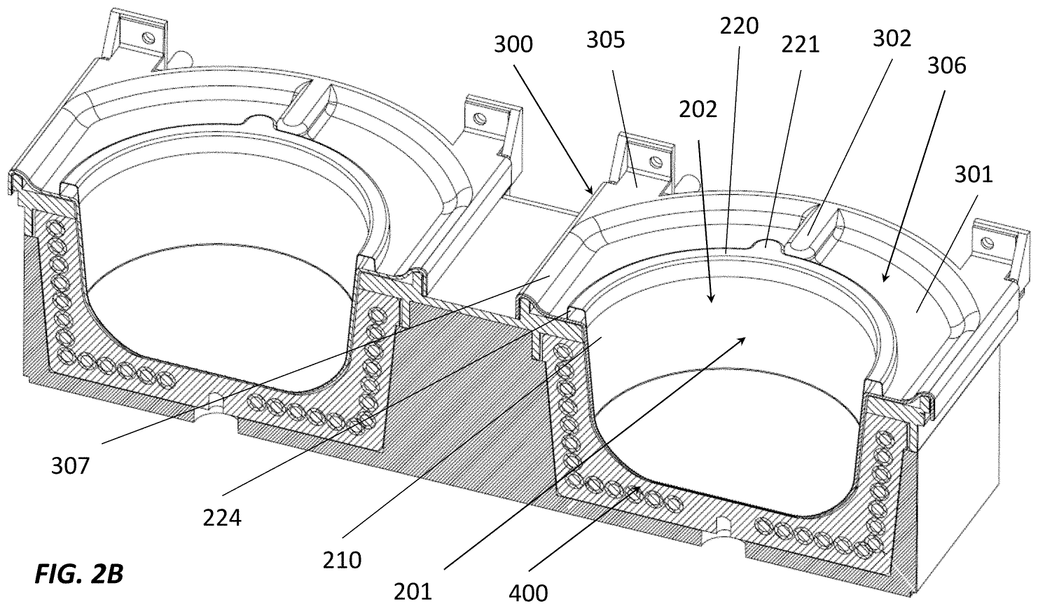

FIGS. 1A and 1B show a device 100 according to an embodiment of the present disclosure for preparing a frozen food product, such as for example ice cream or sorbet, from a liquid mixture. Further details of the device 100 are shown in the FIGS. 2A, 2B, 3A, 3B and 4. The device 100 comprises a first sub-unit 101 which is arranged for preparing a frozen food product in a first cup 200, and a second sub-unit 102 which is arranged for preparing a frozen food product in a second cup 200, different from the first cup 200. The first sub-unit 101 and the second sub-unit 102 are arranged in a similar manner and operate independent from each other, such that two cups 200 of frozen food product can be prepared separate from each other. In alternative embodiments, the device 100 may comprise only a single sub-unit 101, 102, or may be provided with more than two of the sub-units 101, 102. Since the first sub-unit 101 and the second sub-unit 102 are arranged in similar manner, the features of the device 100 will be discussed below only with respect to one of the sub-units 101, 102.

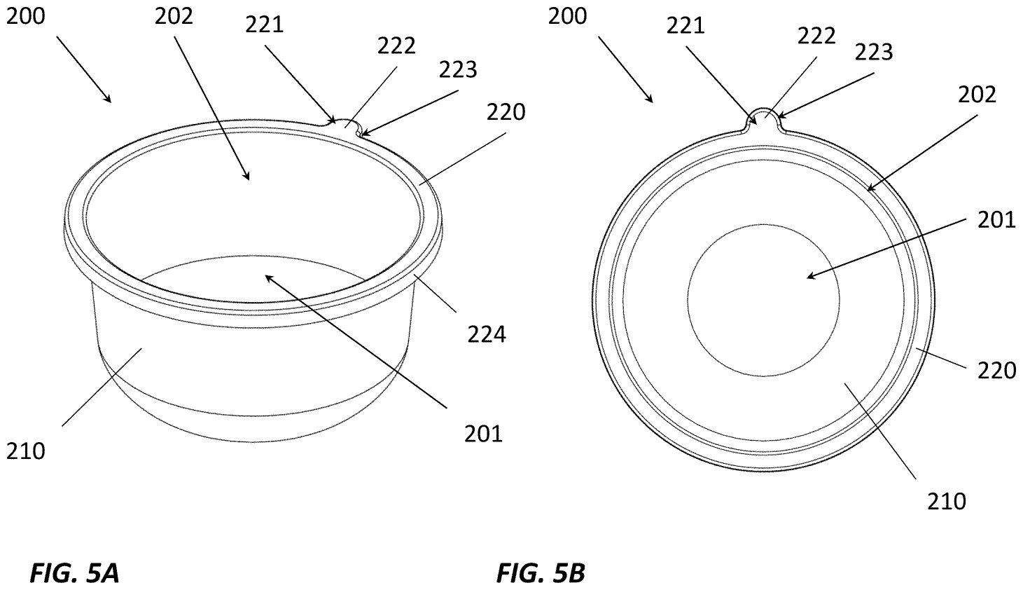

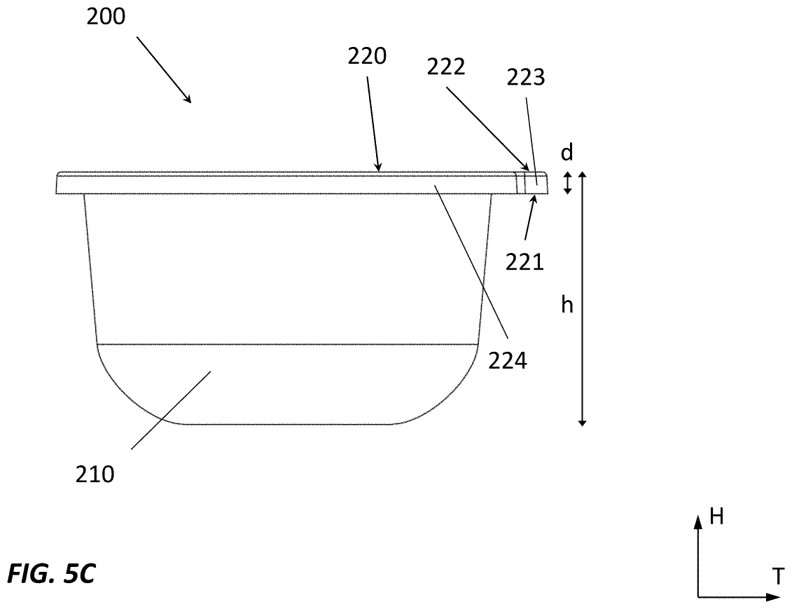

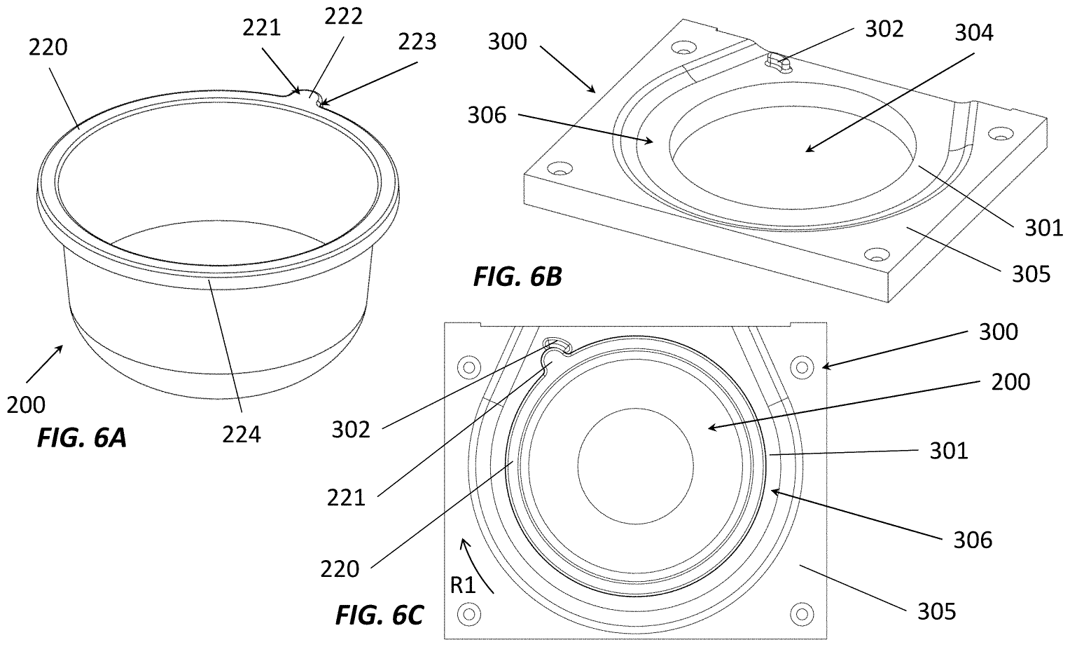

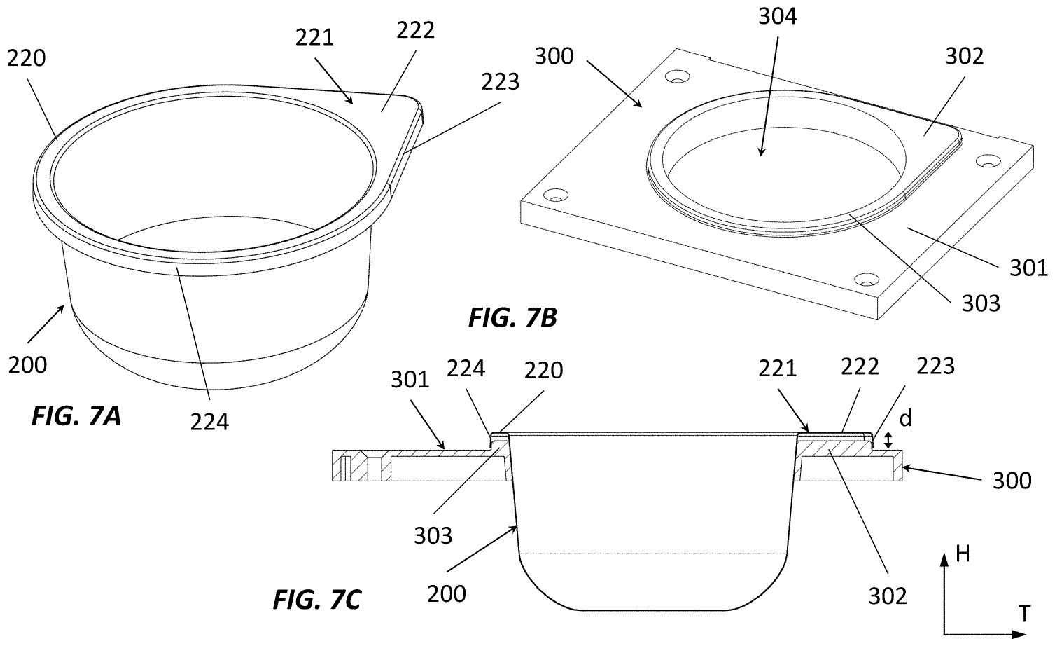

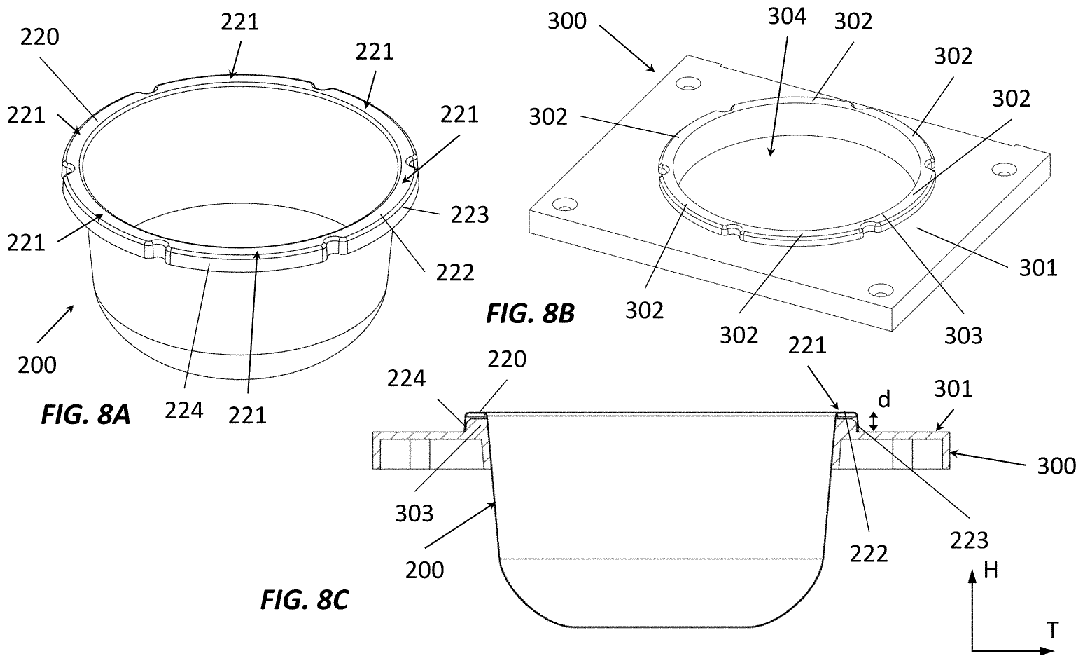

FIGS. 5A-5C and 6A show a cup 200 according to an embodiment of the present disclosure for use with the device 100. Other embodiments of the cup 200 according to the present disclosure are shown in the FIGS. 7A and 8A. The cup 200 comprises a cup wall 210 which encloses a holding volume 201. The holding volume 201 is arranged for holding the liquid mixture therein, and also for holding the frozen food product therein after the frozen food product has been prepared form the liquid mixture. At the top, the cup 200 comprises a top opening 202 via which the holding volume 201 can be accessed. The cup 200 may be pre-filled with the liquid mixture, whereby the top opening 202 is sealed off by one or more sealing elements (not shown), such as a sealing membrane and a lid. The sealing elements can then be taken off the cup 200 before the cup 200 is to be used with the device 100. The cup 200 may also be a reusable cup 200, which is filled with a liquid mixture from a package pre-filled with liquid mixture or with a self-made liquid mixture right before the cup 200 is to be used with the device 100.

The device 100 comprises, as can be seen in FIGS. 1A and 1B and shown in more detail in FIGS. 2A and 2B, at its bottom a cup holder 300 which is arranged for holding the cup 200, preferably in a fixed position, while the frozen food product is being prepared in the cup 200. Therefore, the device 100 comprises a cavity 310 in which the cup 200 can be received via an entrance opening 304.

As can be seen for example in FIG. 2A, the entrance opening 304 of the cavity 310 is located in a first upper surface 301 of the cup holder 300. This first upper surface 301 is formed by a bottom surface 301 in a recessed area 306 in a second upper surface 305 of the cup holder 300. In this arrangement the second upper surface 305 is thus located above the first upper surface 301 in a height direction H. In alternative embodiments, such as for example shown in FIGS. 7A and 7B, the cup holder 300 can also be provided with a single flat first upper surface 301. The first upper surface 301 being located in the recessed area 306 is however advantageous for containing liquid mixture or frozen food product which is spilled accidentally out of the cup 200 in the recessed area 306, such that it is prevented from further spreading over the device 100.

The device 100 also comprises a cooling unit 400, as can be seen in FIGS. 1A and 1B and shown in more detail in FIGS. 2A and 2B. The cooling unit 400n is arranged for cooling the cavity 310 of the cup holder 300, and more specifically for cooling a cup 200 received in the cavity 310. The cooling unit 400 should be arranged to provide sufficient cooling for freezing liquid mixture contained in the cup 200 while preparing a frozen food product from the liquid mixture. The cooling unit 400 may comprise one or more cooling pipes, which are arranged around the cavity 310, and through which a cooling fluid is transported for cooling the cavity 310. The cooling unit 400 may however also be arranged in any other way know to the person skilled in the art for cooling the cavity 310 of a device 100 for preparing a frozen food product from a liquid mixture.

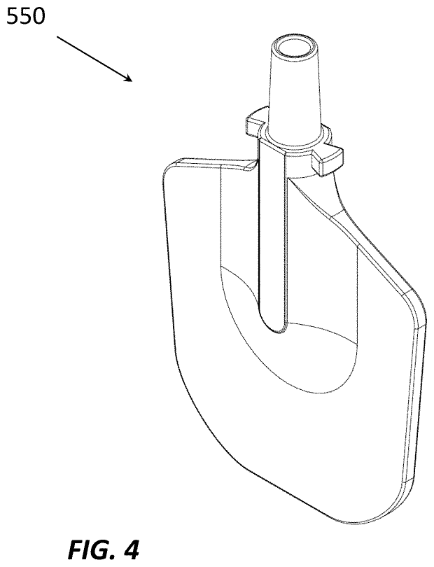

The device 100 also comprises a stirring unit 500 which is arranged above the cup holder 300, as can be seen in FIGS. 1A and 1B. The stirring unit 500 comprises a stirring element 550, which is shown in detail in FIG. 4. The stirring unit 500 is configured for stirring the liquid mixture in the cup 200 by said stirring element 550 for preparing the frozen food product. The stirring element 550 is removably connectable to the stirring unit 500, such that the stirring element 550 can be taken out of the device 100 for cleaning.

The stirring unit 500 comprises a moveable portion 501 which is moveable along a height direction H between a first position and a second position. In the first position, as shown for first sub-unit 101 of the device 100 in FIGS. 1A and 1B, the stirring element 550 is arranged outside of the cup 200, such that it is easily accessible for disconnecting it from the stirring unit 500 for cleaning and for connecting it to the stirring unit 500. In the second position, as shown for the second sub-unit 102 of the device 100 in FIGS. 1A and 1B, the stirring element 550 is arranged inside the cup 200 such that the stirring unit 500 can stir the liquid mixture in the cup 200 by the stirring element 550 for preparing the frozen food product.

The stirring unit 500 is also provided with a protection screen 510, which is shown for both sub-units 101, 102 of the device 100 in FIG. 1A and for the second sub-unit in FIG. 1B. In FIG. 1B, the protection screen 510 has however been omitted for the first sub-unit 101 of the device 100, but only to show the features of the device 100 located behind the protection screen 510. The protection screen 510 extends downwards from the moveable portion 501 of the stirring unit 500, and moves together with the moveable portion 501 of the stirring unit 500. When the moveable portion 501 of the stirring unit 500 is in the second position, the protection screen 510 closes off an area located above the cup 200 and between the cup holder 300 and the moveable portion 501 of the stirring unit 500. This prevents access to the moving stirring element 550 when the frozen food product is being prepared, which is beneficial for safety. A further safety feature is that, in the second position of the moveable portion 501 of the stirring unit 500, the bottom edge 511 of the protection screen 510 supports on the first upper surface 301 near an edge 307 of the recessed area 306, such that it is difficult to get underneath the protection screen 510 and lift it up to gain access to the closed off area. The protection screen 510 is also beneficial for the cleanliness of the device 100, since it contains spilled liquid mixture or frozen food product in the closed off area, and prevents it from further spreading over the device 100.

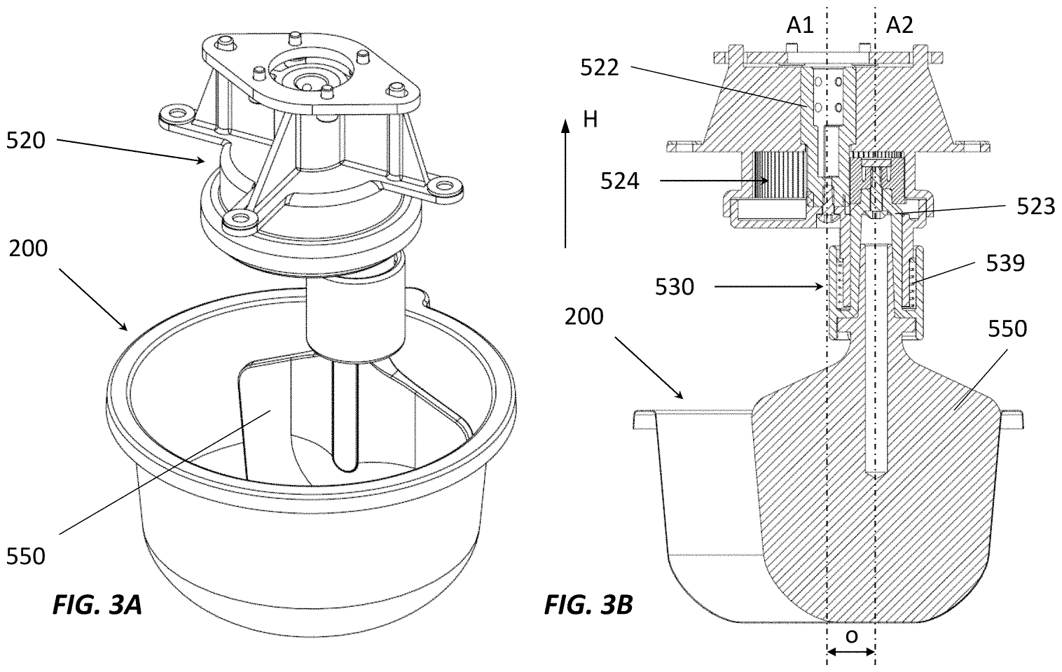

The stirring unit 500 also comprises a drive system 520 for driving the stirring motion of the stirring element 550 in the cup 200, which drive system 520 is shown in detail in the FIGS. 3A and 3B. The drive system 520 comprises a motor (not shown) which is coupled to a first rotation shaft 522 for rotating the first rotation shaft 522. The first rotation shaft 522 is arranged in the height direction H along a first axis A1, which goes centrally through the cup 200 when received in the cavity 310 of the cup holder 300. The first rotation shaft 522 is connected to a secondary rotation shaft 523 by a planetary gear mechanism 524. The secondary rotation shaft 523 is arranged in the height direction H along a second axis A2, which goes centrally through the stirring element 550. The second axis A2 is located at a predetermined offset o from the first axis A1. The stirring element 550 is connected to the second rotation shaft 523 by a coupling mechanism 530. In this configuration, the motor rotating the first rotation shaft 522 causes the rotation of the stirring element 550 together with the second axis A2 around the first axis A1 and simultaneously the rotation of the stirring element 550 around the second axis A2. In alternative embodiments, other configurations of the drive mechanism may be used for rotating the stirring element 550, such as for example a drive mechanism with a single rotation shaft for rotating the stirring element 550 around a single axis.

The coupling mechanism 530 for connecting the stirring element 550 to the second rotation shaft 523 is provided with a spring 539 or other biasing element which is arranged for pushing the stirring element 550 downwards. This spring 539 causes the stirring element 550 to be pushed firmly against the cup 200 when the moveable portion 501 of the stirring unit 500 is in the second position, such that there is a good contact between the stirring element 550 and the cup 200 for scraping frozen liquid mixture from the cup wall 210 when frozen food product is being prepared from the liquid mixture in the cup 200.

The cup 200, as shown in the FIGS. 5A-5C. 6A, 7A and 7B, is provided such that it can easily be taken out of the cup holder 300 of the device 100. Therefore, the cup 200 comprises at its top a circumferential flange 220 surrounding the top opening 202. The circumferential flange 220 extends outwards and sideways from the cup 200, i.e. away from the cup 200 in radial or transverse directions T perpendicular to the height direction H. Furthermore, the cup 200 has a height h such that the cup 200 extends a distance d above the first upper surface 301 of the cup holder 300 when the cup 200 is received in the cavity 310 of the cup holder 300. For this purpose, the cavity 310 of the cup holder 300 has a height equal to the height h of the cup 200 minus the distance d that the cup 200 extends above the first upper surface of the cup holder 300. In the embodiments shown, the distance d is approximately 5 mm. In alternative embodiments, the distance d can however also be larger or smaller. In some embodiments, the distance d is in the range from 2-15 mm. With the cup 200 extending the distance d above the first upper surface 301 of the cup holder 300, the circumferential flange 220 at the top of the cup 200 is thus located at the distance d above the first upper surface 301 of the cup holder 300. In this way the circumferential flange 220 of the cup 200 is easily accessible for grabbing it from the sides for taking it out of the cavity 310 of the cup holder 300.

In the embodiments shown, the circumferential flange 220 is provided along at least a part of its circumference with a second extension 224 which extends downwards from the circumferential flange 220 up to the first upper surface 301 of the cup holder 300 when the cup 200 is received in the cavity 310 of the cup holder 300. The second extension 224 extends thus downwards from the circumferential flange 220 over the distance d that the cup 200 extends above the first upper surface 301. In alternative embodiments, the distance over which the second extension 224 extends downwards can however also be smaller. The downwards second extension 224 is beneficial since it offers a larger surface to grab onto for easily taking the cup 200 out of the cavity 310 of the cup holder 300.

The cup 200 and the cup holder 300 of the device 100 are also provided for preventing the cup 200 from rotating in the cavity 310 of the cup holder 300 when the stirring unit 500 is stirring the stirring element 550 in the cup 200 for preparing the frozen food product from the liquid mixture.

For the embodiment of the cup 200 shown in FIGS. 5A and 6A, the cup holder 300, such as shown in FIG. 2A and also in FIG. 6B, is therefore provided on the first upper surface 301 with a single first protrusion 302. The first protrusion 302 extends upwards from the first upper surface 301 in the height direction H up to the distance d that the cup 200 extends above the first upper surface 301. In alternative embodiments, the first protrusion 302 may however be lower or higher. The circumferential flange 220 of the cup 200, on the other hand, is provided with a single first extension 221. A first part 222 of the first extension 221 extends outwards and sideways from the circumferential flange 220, i.e. away from the cup 200 and the circumferential flange 220 in a radial or transverse direction T. A second part 223 of the first extension 221 extends downwards from the first part 222 of the first extension 221. When the cup 200 is received in the cavity 310 of the cup holder 300, such as shown in FIG. 2B and FIG. 6C, the second part 223 of the first extension 221 contacts a side of the first protrusion 302 along a rotation direction R1 around the first axis A1, such that the first protrusion 302 functions as a stop for the first extension 221 and thus the cup 220 to prevent rotation of the cup 200 in the cavity 310 of the cup holder 300. It should be remarked that the cup 200 may also be received in the cavity 310 of the cup holder 300 with the first extension 221 positioned away from the first protrusion 302 and thus not in contact with the first protrusion 302. A rotation of the cup 200 in the cavity 310 of the cup holder 300 would then move the first extension 221 towards the first protrusion 302 until the first extension 221 contacts the first protrusion 302, such as shown in FIG. 2B and FIG. 6C.

In alternative embodiments, the first extension 221 of the circumferential flange 220 can also be provided without the downwards extending second part 223, in which case it would be an edge of the first part 222 of the first extension 221 that is contacting the first protrusion 302 to prevent the rotation of the cup 200 in the cavity 310 of the cup holder 300. In combination with such embodiments it may be beneficial to provide the first protrusion 302 such that it extends upwards from the first upper surface 301 of the cup holder 300 higher than the distance d that the cup 200 extends above the first upper surface 301. This would aid in preventing the at first extension 221 of the circumferential flange 220 from accidentally slipping over the first protrusion 302.

In another embodiment of the present disclosure, the cup 200 and the cup holder 300 of the device 100 may be arranged such as shown in the FIGS. 7A-7C to prevent the cup 200 from rotating in the cavity 310 of the cup holder 300.

In this embodiment, the cup holder 300 is provided on the first upper surface 301 with a single first protrusion 302. The first protrusion 302 extends upwards from the first upper surface 301 in the height direction H over a distance which is smaller than the distance d that the cup 200 extends above the first upper surface 301. In alternative embodiments, the first protrusion 302 may also extend upwards from the first upper surface 301 in the height direction H up to the distance d that the cup 200 extends above the first upper surface 301. The circumferential flange 220 of the cup 200, on the other hand, is provided with a single first extension 221. A first part 222 of the first extension 221 extends outwards and sideways from the circumferential flange 220, i.e. away from the cup 200 and the circumferential flange 220 in a radial or transverse direction T. A second part 223 of the first extension 221 extends downwards from the first part 222 of the first extension 221. With this embodiment, the cup 200 can be received in the cavity 310 of the cup holder 300 with the first part 222 of the first extension 221 arranged over the correspondingly shaped first protrusion 302 on the first upper surface 301 of the cup holder 300, such as shown in the cross section of FIG. 7C. In this arrangement, the second part 223 of the first extension 221 contacts opposing sides of the first protrusion 302 along a rotation direction R1 around the first axis, such that the first protrusion 302 functions as a stop for the first extension 221 and thus the cup 220, which prevents rotation of the cup 200 in the cavity 310 of the cup holder 300 in opposite senses.

In this embodiment, the cup holder 300 is also provided with a second protrusion 303 which extends upwards from the first upper surface 301 of the cup holder 300 in the height direction H. The second protrusion 303 is a circumferential protrusion that surrounds the entrance opening 304 of the cavity 310 of the cup holder 300. The second protrusion 303 extends upwards from the first upper surface 301 in the height direction H over a distance which is smaller than the distance d that the cup 200 extends above the first upper surface 301. The second protrusion 303 is beneficial for supporting the second extension 224 of the circumferential flange 220 of the cup 200, for example when the second extension 224 is grabbed onto for taking the cup 200 out of the cavity 310 of the cup holder 300. In alternative embodiments, the second protrusion 303 may also extend upwards from the first upper surface 301 in the height direction H up to the distance d that the cup 200 extends above the first upper surface 301, in which case the second protrusion is also beneficial for supporting the circumferential flange 220 of the cup 200. In alternative embodiments, the second protrusion 303 can however also be omitted.

In this embodiment, the first protrusion 302 on the first upper surface 301 of the cup holder 300 extends sideways from the second protrusion 303 on the first upper surface 301 of the cup holder 300, such that the first protrusion 302 and the second protrusion 303 are linked to each other. In alternative embodiments, the first protrusion 302 may however also be separate from the second protrusion 303.

In another embodiment of the present disclosure, the cup 200 and the cup holder 300 of the device 100 may be arranged such as shown in the FIGS. 8A-8C to prevent the cup 200 from rotating in the cavity 310 of the cup holder 300.

In this embodiment, the cup holder 300 is provided on the first upper surface 301 with six first protrusions 302. In alternative embodiments, the number of first protrusions 302 may however also be lower or higher. The first protrusions 302 extend upwards from the first upper surface 301 in the height direction H over a distance which is smaller than the distance d that the cup 200 extends above the first upper surface 301. In alternative embodiments, the first protrusions 302 may also extend upwards from the first upper surface 301 in the height direction H up to the distance d that the cup 200 extends above the first upper surface 301. The first protrusions 302 are arranged rotationally symmetric around the entrance opening 304 of the cavity 310, i.e. at equal distances from each other. The circumferential flange 220 of the cup 200, on the other hand, is provided with a corresponding number of first extensions 221, which are arranged rotationally symmetric on the circumferential flange 220, i.e. at equal distances from each other. A first part 222 of each of the first extensions 221 extends outwards and sideways from the circumferential flange 220, i.e. away from the cup 200 and the circumferential flange 220 in a radial or transverse direction T. A second part 223 of each of the first extensions 221 extends downwards from the first part 222. With this embodiment, the cup 200 can be received in the cavity 310 of the cup holder 300 with the first part 222 of each of the first extensions 221 arranged over one the correspondingly shaped first protrusions 302 on the first upper surface 301 of the cup holder 300, such as shown in the cross section of FIG. 8C. In this arrangement, the second part 223 of each of the first extensions 221 contacts opposing sides of the corresponding first protrusion 302 along a rotation direction R1 around the first axis, such that the first protrusions 302 function as stops for the first extensions 221 and thus the cup 220, which prevent rotation of the cup 200 in the cavity 310 of the cup holder 300 in opposite senses. The rotationally symmetric arranged first protrusions 302 on the first upper surface 301 of the cup holder 300 and the rotationally symmetric arranged first extensions 221 on the circumferential flange 220 of the cup 200 offer the advantage that the cup 200 can be received in different positions in the cavity 310 of the cup holder 300, each position being rotated 60° with respect to each other. This makes it easier to position the cup 200 correctly and quickly in the cavity 310 of the cup holder 300.

In this embodiment, the cup holder 300 is also provided with a second protrusion 303 which extends upwards from the first upper surface 301 of the cup holder 300 in the height direction H. The second protrusion 303 is a circumferential protrusion that surrounds the entrance opening 304 of the cavity 310 of the cup holder 300. The second protrusion 303 extends upwards from the first upper surface 301 in the height direction H over a distance which is smaller than the distance d that the cup 200 extends above the first upper surface 301. The second protrusion 303 is beneficial for supporting the second extension 224 of the circumferential flange 220 of the cup 200, for example when the second extension 224 is grabbed onto for taking the cup 200 out of the cavity 310 of the cup holder 300. In alternative embodiments, the second protrusion 303 may also extend upwards from the first upper surface 301 in the height direction H up to the distance d that the cup 200 extends above the first upper surface 301, in which case the second protrusion is also beneficial for supporting the circumferential flange 220 of the cup 210. In alternative embodiments, the second protrusion 303 can however also be omitted.

In this embodiment, the first protrusions 302 on the first upper surface 301 of the cup holder 300 extend sideways from the second protrusion 303 on the first upper surface 301 of the cup holder 300, such that the first protrusions 302 and the second protrusion 303 are linked to each other. In alternative embodiments, the first protrusions 302 may however also be separate from the second protrusion 303.

### REFERENCES

100 device
200 cup
201 holding volume
202 top opening
210 cup wall
220 circumferential flange
221 first extension
222 first part
223 second part
224 second extension
300 cup holder
301 first upper surface
302 first protrusion
303 second protrusion
304 entrance opening
305 second upper surface
306 recessed area
307 edge
310 cavity
400 cooling unit
500 stirring unit
501 moveable portion
510 protection screen
511 bottom edge
520 drive system
522 first rotation shaft
523 second rotation shaft
524 planetary gear mechanism
530 coupling mechanism
539 spring
550 stirring element
H height direction
T transverse direction
R1 rotation direction
h height
d distance

1. A cup for a device for preparing a frozen food product from a liquid mixture, wherein the cup is arranged for preparing the frozen food product therein from the liquid mixture with a stirring element of the device stirring the liquid mixture in the cup while the cup is being cooled with a cooling unit of the device, wherein the device comprises a cup holder comprising a cavity arranged for receiving the cup, wherein the cup holder comprises a first upper surface surrounding an entrance opening of the cavity, wherein the cup holder is provided on the first upper surface with at least one first protrusion extending upwards from the first upper surface, wherein the cup has a predetermined height such that the cup, when the cup is received in the cavity of the cup holder of the device, extends a predetermined distance above the first upper surface of the cup holder, wherein the cup comprises at its top a circumferential flange, wherein the circumferential flange is provided with at least one first extension, wherein the at least one first extension is arranged such that, when the cup is received in the cavity of the cup holder of the device, the at least one first extension contacts the at least one first protrusion for preventing rotation of the cup in the cavity.

2. The cup according to claim 1, wherein the predetermined distance is at least 2 mm.

3. The cup according to claim 1, wherein, when the at least one first protrusion extends upwards from the first upper surface up to at least the predetermined distance above the first upper surface, the at least one first extension extends sideways from the circumferential flange and is configured to contact the at least one first protrusion when the cup is received in the cavity of the cup holder of the device.

4. The cup according to claim 1, wherein at least a part of the at least one first extension extends downwards with respect to the circumferential flange such that it is configured to contact the at least one first protrusion when the cup is received in the cavity of the cup holder of the device.

5. The cup according to claim 1, wherein the circumferential flange is provided at least along a part of its circumference with a second extension which extends downwards from the circumferential flange.

6. The cup according to claim 5, wherein the second extension extends downwards from the circumferential flange up to the first upper surface when the cup is received in the cavity of the cup holder of the device.

7. The cup according to claim 1, wherein the at least one first extension is configured to contact the at least one first protrusion on opposing sides of the at least one first protrusion when the cup is received in the cavity of the cup holder of the device.

8. The cup according to claim 1, wherein the circumferential flange is provided with a plurality of the first extensions which are arranged rotationally symmetric on the circumferential flange.

9. A device for preparing a frozen food product from a liquid mixture, the device comprising:
a cup in which the frozen food product is to be prepared from the liquid mixture;
a cup holder comprising a cavity receiving the cup, wherein the cup holder comprises a first upper surface surrounding an entrance opening of the cavity;
a cooling unit configured for cooling the cavity of the cup holder; and
a stirring unit configured for stirring the liquid mixture in the cup with a stirring element for preparing the frozen food product, wherein the stirring unit comprises a drive system for driving the stirring motion of the stirring element in the cup;
wherein the cup extends a predetermined distance above the first upper surface of the cup holder, wherein the cup comprises at its top a circumferential flange, wherein the circumferential flange is provided with at least one first extension, wherein the cup holder is provided on the first upper surface with at least one first protrusion extending upwards from the first upper surface, wherein the at least one first extension and the at least one first protrusion are arranged such that the at least one first extension contacts the at least one first protrusion such that it is configured to prevent rotation of the cup in the cavity.

10. The device according to claim 9, wherein the predetermined distance is at least 2 mm.

11. The device according to claim 9, wherein the at least one first protrusion extends upwards from the first upper surface up to at least the predetermined distance above the first upper surface, and wherein the at least one first extension extends sideways from the circumferential flange such that it is configured to contact the at least one first protrusion.

12. The device according to claim 9, wherein at least a part of the at least one first extension extends downwards with respect to the circumferential flange such that it is configured to contact the at least one first protrusion.

13. The device according to claim 9, wherein the circumferential flange is provided at least along a part of its circumference with a second extension which extends downwards from the circumferential flange.

14. The device according to claim 9, wherein the cup holder is provided on the first upper surface at a circumference of the cavity with a second protrusion which extends upwards from the first upper surface and which surrounds the entrance opening of the cavity.

15. The device according to claim 14, wherein the second protrusion extends upwards from the first upper surface up to the predetermined distance above the first upper surface.

16. The device according to claim 9, wherein the at least one first extension is configured for contacting the at least one first protrusion on opposing sides of the at least one first protrusion.

17. The device according to claim 9, wherein the circumferential flange is provided with a plurality of the first extensions which are arranged rotationally symmetric on the circumferential flange.

18. The device according to claim 9, wherein the cup holder is provided with a plurality of the first protrusions which are arranged rotationally symmetric around the entrance opening of the cavity.

19. The device according to claim 9, wherein the cup holder comprises in a second upper surface a recessed area surrounding the entrance opening of the cavity, wherein a bottom surface of the recessed area forms the first upper surface of the cup holder.

20. The device according to claim 19, wherein the stirring unit is arranged above the cup holder, and wherein the stirring unit comprises a moveable portion which is moveable along a height direction between a first position wherein the stirring element is arranged outside of the cup and a second position wherein the stirring element is arranged inside the cup for stirring the liquid mixture for preparing the frozen food product, wherein the stirring unit is provided with a protection screen extending downwards from the moveable portion of the stirring unit, wherein the protection screen is arranged such that a bottom edge of the protection screen supports on the first upper surface when the moveable portion of the stirring unit is in the second position.
